(19) United States
(12) Patent Application Publication
(10) Pub. No.: US 2006/0283057 A1
(43) Pub. Date: Dec. 21, 2006

(54) License plate identification display

(76) Inventor: Robert Andrew Gall, Parker, CO (US)

Correspondence Address: THE MAXHAM FIRM, 9330 SCRANTON ROAD, SUITE 350, SAN DIEGO, CA, 92121, US

(21) Appl. No.: 11/509,294

(22) Filed: Aug. 23, 2006

Related U.S. Application Data
(63) Continuation of application No. 10/829,643, filed on Apr. 22, 2004.

(51) Int. Cl. G09F 7/00

(52) U.S. Cl. 40/200

(57) ABSTRACT

Additional license plate identification display configurations, providing official license plate vehicle identification and motorist choice of new indicia personalization. The new identification indicia is compatible with, or in lieu of, all present alphanumeric license plate displays. The identification marks and symbol indicia are embossed or are computer generated, duplicating the alphanumeric placement process on both sequential and personalized motor vehicle license plates.

### FIELD OF THE INVENTION

This invention relates to additional identification indicia for display on government issued license plates, the sort affixed to the back, and often to the front of motor vehicles such as automobiles, trucks and motorcycles.

### BACKGROUND OF THE INVENTION

In the United States, all states require motor vehicle owners to purchase and display a state authorized rear license plate, also known as a license tag. Many states, 31, and the District of Columbia require a front license plate. Most state license plates display a wide variety of pictorial background graphics for ornamentation and plate decoration. However, from the first license plate over 100 years ago to the present date, only alphanumerics, that is, 26 letters and 10 numbers, have been used for official license plate identification. Personalized or “vanity” plates are also limited to alphanumerics for state identification. When designs as California's heart for kid's plates or the Oregon's tree emblem is on a license plate, these designs are considered ornamental, and are read as a blank by law enforcement officials for identification purposes.

The number of motor vehicles, especially in populated states, creates the requirement for seven alphanumerics, in various combinations, to accommodate future vehicle growth. That growth has impacted the personalizing of license plates. After 25 years of personalized plates, few, simple, short, and popular alphanumeric combinations remain available. Motorists desire for personalization now manifests itself in unique license plate frames in lieu of vanity plates, which denies DMV revenue to already cash-strapped states.

Gehlot in U.S. Pat. No. 6,641,038 B2 describes a registration plate which may or may not replace existing license plates. This unit contains electronic data using alphanumerics in a computing unit displaying vehicle information, and does not have an economical advantage as a license plate replacement.

An informational sign is disclosed by Amirian in U.S. Pat. No. 5,878,516. Here, a sign-bearing billboard for personal information is offered in addition to a license plate. This unit displays information rather than project official identification.

A vehicle license tag is described by Sigler in U.S. Pat. No. 2,338,824. This tag provides for license plate life extension by using metal registration tags, and demonstrates that only 36 alphanumerics were used for official identification 60 years ago.

The fact is, 36 alphanumerics have over a century of use. But now a seven indicia maximum, a state choice of alphanumeric sequence, and population growth are limiting personalized license plate choices. No prior art addresses these factors.

Thus, there is a need and desire of many US motorists for individual personalization especially on their license plate, which is the largest emblem on their vehicle. This need for license plate personalization beyond background graphics, sports emblems, and specialty plates are areas not being addressed by existing state license plate options. Additionally, an economic need exists for all states without raising taxes or fees, to maximize DMV revenue, especially, optional revenue from personalized state license plates.

### SUMMARY OF THE INVENTION

The above noted problems are overcome with this invention by introducing new identification indicia which can be used for license plate identity. The following marks and symbol(s) can be used in lieu of in addition to alphanumerics, or stand alone as identifying indicia.

The dollar, “$”, is a world-wide recognizable mark, used to quantify alphanumerics. The cents, “¢”, is the mark used to depict the currency of more than twenty countries. Both the dollar and cents marks are used in an informational capacity only.

The question mark, “?”, since circa 1869 has been used to indicate an unknown or as a mark to indicate a direct question. The exclamation point or mark, “!”, since circa 1824 has been used to display strong feelings and/or excitement. Both the exclamation and question marks are used as language symbols, not as identification arks.

The “ [symbol] ”, is my design for a dual lightning bolt identification symbol(s). It is indicative of speed and suitable for license plate application.

Use of my dual lightning bolt symbol(s) , dollar, cents, question, and exclamation marks in an identification capacity is outside their traditional use for information or language only. Although these symbols may be used as substitutes for, or in addition to, alphanumerics presently on sequential license plates, it is anticipated that any of these identification symbols would be reserved for personalized and vanity plates to provide additional state Department of Motor Vehicle revenue.

Today, there is a need for front license plate compliance in many states. California has a 20% non-compliance factor. Colorado and Nevada are approaching 15%. My research proves, motorists with personalized plates have a higher front plate display, than sequential license plate owners. Since my invention encourages motorists to purchase a vanity plate, law enforcement receives the spin-off benefit of a higher level of front license plate display compliance.

An alternative embodiment of my invention is to utilize any combination of the marks and symbol(s) for identification, in addition to, or in lieu of, numbers on credit, bank, or debit, cards or as a PIN associated with these respective cards.

It is a principal object of this invention to provide five or more new identification indicia for use on state authorized personalized or sequential license plates.

Another object is to give motorists what they want, additional choices of vehicle personalization, now unavailable with existing alphanumerics.

A further object is to make available for re-issue, already issued personalized plates. For example, GOT MLK, can be re-issued as GOT MLK$, GOT MLK?, or GOT MLK!, generating additional Department of Motor Vehicle state revenue.

Yet another object is the unforeseen advantage of additional front license plate compliance in two plate states.

Still a further object is to provide additional identification indicia for increased personal identity security on credit, bank, or debit, cards and associated PINs.

### BRIEF DESCRIPTION OF THE DRAWINGS

Details of the invention, and of preferred embodiments thereof, will be further understood upon reference to the drawings, wherein:

FIG. 1A-1E are front views of five license plates displaying the invention.

FIG. 2A-2E are five front views illustrating another embodiment of the invention.

FIG. 3A-3E are front views of one license plate available for re-issue.

FIG. 4 is a front view of a credit card displaying an alternate embodiment.

### DESCRIPTION OF PREFERRED EMBODIMENTS

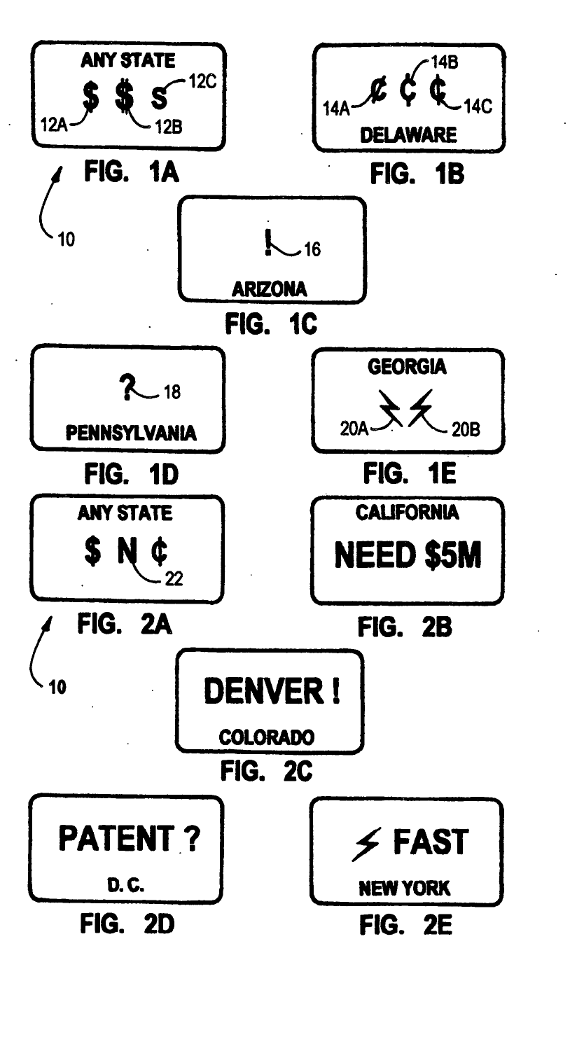

Referring to FIG. 1A, license plate 10 is shown with identification mark 12A. Mark 12B adjacent to mark 12C are displayed as variations of mark 12A. FIG. 1B is shown with identification mark 14A. Mark 14B adjacent to mark 14C are displayed as variations of mark 14A. FIG. 1C is a display of identification mark 16, while FIG. 1D displays identification mark 18. Identification symbol 20A adjacent to symbol 20B are displayed as dual symbol unit in FIG. 1E.

As seen in FIG. 2A, license plate 10 displays identification mark 12A, in combination with alphanumeric 22, adjacent to mark 14C. FIGS. 2B-2D shows various personalized plate combinations of alphanumerics 22, displayed with marks 12A, 16, 18. FIG. 2E shows symbol 20B in single symbol display adjacent to alphanumerics 22.

The manufacture of marks 12A-C, 14A-C, 16, 18 and symbol(s) 20A-B duplicates the production of embossing alphanumerics 22 on state license plates 10. A metal die of marks 12A-C, 14A-C, 16, 18 and symbol(s) 20A-B, in the dimensions of state requirements for existing alphanumerics 22, is cast to emboss license plate 10 using state alphanumeric embossment techniques. There would be no production difference between identification mark 12A and alphanumeric “five”. The personalized plate result would be $5, state identified as Dollar Five, (see FIG. 2B).

The marks 12A-C, 14A-C, 16, 18 and symbol(s) 20A-B would be computer generated in the same manner as alphanumerics 22 for placement on flat vs. embossed license plates. Known as the Azon process, it is used by Delaware for all state plates, and by Colorado for personalized license plates.

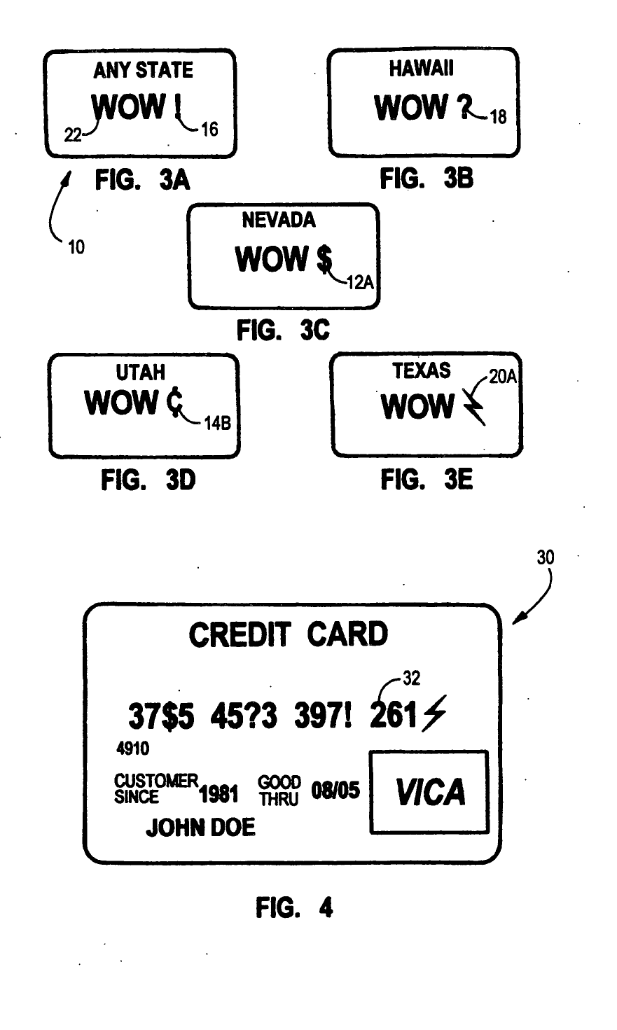

In the embodiment of FIGS. 3A-3E, a personalized license plate 10 is available for re-issue when identification marks 12A, 14B, 16, 18 and symbol 20A are combined with personalized, previously issued alphanumerics 22.

While the discussion of the invention has emphasized its use in connection with license plate identification indicia, identification marks and symbol(s), according to the invention could be used as identifying indicia as shown in FIG. 4. In this alternative embodiment, credit card 30 displays identification marks 12A, 16, 18, and symbol 20B in lieu of numbers 32. Placement and manufacture of marks 12A-C, 14A-C, 16, 18 and symbol(s) 20A-B duplicates the embossing process of numbers 32.

While certain specific relationships, materials and other parameters have been detailed in the above description of preferred and alternate embodiments, those can be varied, where suitable, with similar results. Other applications, variation and ramifications of the present invention will occur to those skilled in the art upon reading the present disclosure. Those are intended to be included within the scope of this invention as defined in the appended claims.

I claim:

1-24. (canceled)

25. A method to extend a personalized vehicle license plate having alphanumeric identification indicia thereon to additional issued license plates with the same alphanumeric characters, the method comprising:
adding additional, non-alphanumeric identification indicia selected from the group consisting of a dollar mark, a cents mark, an exclamation mark, a question mark, a lightning bolt symbol; and
preparing to form the license plate with the alphanumeric identification indicia and at least one of said non-alphanumeric identification indicia thereon, thereby enabling a license plate issuing entity to issue more than one personalized license plate with the same alphanumeric identification indicia thereon.

26. The method of claim 25, wherein a non-alphanumeric indicia is a dollar mark.

27. The method of claim 25, wherein a non-alphanumeric indicia is a cents mark.

28. The method of claim 25, wherein a non-alphanumeric indicia is a exclamation mark.

29. The method of claim 25, wherein a non-alphanumeric indicia is a question mark.

30. The method of claim 25, wherein a non-alphanumeric indicia is a lightning bolt symbol.

31. A method to extend a personalized vehicle license plate to additional issued license plates having alphanumeric characters, the method comprising:
preparing an alphanumeric identification indicia for a license plate;
adding additional, non-alphanumeric identification indicia to said alphanumeric indicia; and
preparing to form the license plate with the alphanumeric identification indicia and at least one non-alphanumeric identification indicia thereon, thereby enabling a license plate issuing entity to issue more than one personalized license plate with the same alphanumeric identification indicia thereon.

32. The method of claim 31, wherein a non-alphanumeric indicia is a dollar mark.

33. The method of claim 31, wherein a non-alphanumeric indicia is a cents mark.

34. The method of claim 31, wherein a non-alphanumeric indicia is a exclamation mark.

35. The method of claim 31, wherein a non-alphanumeric indicia is a question mark.

36. The method of claim 31, wherein a non-alphanumeric indicia is a lightning bolt symbol.

37. A method to enable a vehicle license plate issuing entity to issue a personalized vehicle license plate having non-alphanumeric identification indicia thereon, the method comprising:
selecting at least one non-alphanumeric identification indicia for the license plate; and
preparing to form the personalized license plate with only said at least one non-alphanumeric identification indicia thereon.

38. The method of claim 37, wherein said at least one non-alphanumeric identification indicia is selected from the group consisting of a dollar mark, a cents mark, an exclamation mark, a question mark, a lightning bolt symbol.

39. The method of claim 37, wherein said at least one non-alphanumeric indicia is a dollar mark.

40. The method of claim 37, wherein said at least one non-alphanumeric indicia is a cents mark.

41. The method of claim 37, wherein said at least one non-alphanumeric indicia is a exclamation mark.

42. The method of claim 37, wherein said at least one non-alphanumeric indicia is a question mark.

43. The method of claim 37, wherein said at least one non-alphanumeric indicia is a lightning bolt symbol.
